(19) United States
(12) Patent Application Publication
(10) Pub. No.: US 2025/0081983 A1
(43) Pub. Date: Mar. 13, 2025

(54) A METHOD OF PROCESSING COCOA BEANS FOR PRODUCING A CHOCOLATE THAT IS HIGH IN ANTIOXIDANT CONTENT, AND CHOCOLATE OBTAINED FROM THE PROCESSED COCOA BEANS

(71) Applicant: MELLOW CHOCOLATE APS, Hvidovre (DK)

(72) Inventor: Jacob KAYA, Frederiksberg (DK)

(73) Assignee: MELLOW CHOCOLATE APS, Hvidovre (DK)

(21) Appl. No.: 18/728,013

(22) PCT Filed: Jan. 13, 2023
(86) PCT No.: PCT/EP2023/050733

§ 371 Date: Jul. 10, 2024

(30) Foreign Application Priority Data
Jan. 14, 2022 (DK) PA202270019

(51) Int. Cl. A23G 1/00; A23G 1/32

(52) U.S. Cl. CPC A23G 1/002; A23G 1/32

(57) ABSTRACT

A method of processing cocoa beans for producing a chocolate that is high in antioxidant content method comprises the steps of selecting a genetic variety of raw fermented cocoa bean having a natural high content of antioxidants, selecting a specific cocoa bean antioxidant-preserving and/or antioxidant-producing roasting profile according to said genetic variety of raw fermented cocoa bean, and roasting the genetic variety of raw fermented cocoa bean according to the selected specific cocoa bean antioxidant-preserving and/or antioxidant-producing roasting profile.

The present invention relates to a method of processing cocoa beans to produce a chocolate or and cocoa mass that is high in antioxidant content.

Cocoa beans are the seeds of the Theobroma cacao, which cocoa beans are processed for chocolate manufacturing initially via harvesting of cocoa pods fermentation of cocoa beans and drying of fermented beans and roasting. Hereafter a roasting process is carried out followed by, the beans undergo a cracking and winnowing procedure, to crack up the roasted cocoa beans and separate the husk from the roasted cocoa beans now referred to as cocoa nibs. In a refining and conching step the nibs are ground in a melanger in one process step or separately in two process steps in a refiner and conche. These steps can be carried out on a 100 wt % cocoa mass or as a finished chocolate recipe with additives such as sugar, cocoa butter, etc. Finally, the chocolate can be tempered, molded, and packaged. These steps are conventional chocolate production steps known to the skilled person, and these steps will not be discussed in more details.

Cocoa bean fermentation and initial drying to reduce moisture result in the breakdown of the storage proteins by endogenous proteases into amino acids and short chain oligopeptides while the polysaccharides are also degrade by invertase to glucose and fructose. The amino acids, oligopeptides, glucose and fructose react with each other during the roasting process to produce the typical cocoa flavour volatiles.

Antioxidants within cocoa beans are in the form of polyphenols. Polyphenols are oxidized by polyphenol oxidase during fermentation and drying which reduce the astringency and bitterness of the beans, thus, enhancing the flavour of cocoa beans. The polyphenols content comprises 12-18 wt % of the whole beans dry weight [Richelle, 2001].

The distribution of the different polyphenols is identified in cocoa as 37% flavanols, 58% proanthocyanidins, and 4% anthocyanidins. The polyphenols are found in polyphenolic cells in unfermented cocoa beans and during fermentation they exude from the cells. The flavanols are essential for cocoa bean flavor and color development, whereas the proanthocyanidins and anthocyanidins contribute to the specific bitterness of unfermented cocoa, [Barisic et al., 2019].

Antioxidants inhibit oxidation, thus inhibits production of free radicals and chain reactions that damage cells. The antioxidants are believed to have a beneficial effect on many health conditions.

The article by Oracz Joanna, Nebesny Ewa. Antioxidant Properties of Cocoa Beans (Theobroma cacao L.): Influence of Cultivar and Roasting Conditions. International Journal of Food Properties. Volume 19, 2016-Issue 6 describes adjust relative air humidity in view of roasting temperatures and roasting duration of cultivars not genetic varieties as in the present invention, and that adjusting relative air humidity in view of roasting temperatures and roasting duration might, for only a few cultivars, result in a minor increase in TPC (Total Phenolic Content).

In the study of this article some cultivars of cocoa beans are roated at different humidity and temperatures, and TPC is determined after roasting. D1 does not select any roasting temperature of a genetic variety in view of making chocolate having high antioxidant content. It should in this respect be noted that seeds planted from a variety grow true to type, whereby the offspring retains the parent plant's unique characteristics, while seeds planted from a cultivar will most likely not be true to type. So a cultivar does not automatically, or inherently, preserve its unique characteristics between sequential growings and batches, as is relied on for the present invention, which feature is important for consistent and cost-effective manufacturing of chocholate with high antioxidant content.

The patent application SU65817 A1 concerns a method of manufacturing a chocholate having a high content of sugar wherein 40% ground cocoa mass is mixed with 60% sugar. Cocoa beans are however not synonymous with cocoa mass. As such cocoa beans are whole unrefined cocoa beans that can be obtained fresh and wet, fermented or dried, whereas cocoa mass is a mixture of refined cocoa ingredients which can be selected from the list of refined liquid cocoa beans, cocoa butter, dry cocoa powder, etc. Typically, cocoa mass will be a liquid or molded mass to which a large amount of cocoa butter has been added.

It is a main aspect of the present inventions to optimize the processing of cocoa beans to be used in production of chocolate or cocoa mass, so that the content of naturally occurring antioxidants are preserved to a level as high as possible.

The novel and unique features whereby this and other aspects is/are achieved consist in a method of producing a high-antioxidant containing chocolate or cocoa mass comprising the steps of
a) selecting a genetic variety of raw fermented cocoa bean having a natural high content of antioxidants,
b) selecting a specific cocoa bean antioxidant-preserving and/or antioxidant-producing roasting profile according to said genetic variety of raw fermented cocoa bean, wherein at least a cocoa bean end temperature and a roasting period is established and selected, and wherein the cocoa bean end temperature is the maximum temperature that the genetic variety of raw fermented cocoa beans reach during roasting according to said specific cocoa bean antioxidant-preserving and/or antioxidant-producing roasting profile, and
c) roasting the genetic variety of raw fermented cocoa bean according to said specific cocoa bean antioxidant-preserving and/or antioxidant-producing roasting profile.

Cocoa beans are fermented to prevent growth of bacteria, fungi and mould, and to form curtain flavor pre-cursors. After fermentation at the farm the cocoa beans are dried, typically on the ground, concrete platios or on rolling beds under direct or indirect sunlight, at the risk of biological contamination and insect attacks. Therefore the raw fermented dry cocoa beans need roasting to kill microorganisms, and to develop natural taste and flavor compounds in the beans. At the chocolate production facility the beans are sorted and roasted. When cocoa beans are roasted flavours develop, bacteria are killed, and moisture content is reduced.

Within the context of the present invention the term “roasting profile” means establishing and selecting at least a cocoa bean end temperature and a roasting period that complies with the above requirements and also make a chocolate that is tasty and safe to consume. Further the term “cocoa bean end temperature” is to understood as the final roasting temperature,-thus the maximum temperature that the cocoa beans reach during roasting.

The natural content of antioxidants of a selecting genetic variety of raw fermented cocoa bean may preferably be at least 100 Gallic acid equivalents/g total dry weight.

A cocoa bean can be roasted whole, in many different sizes, as nibs or as a liquid cocoa mass. Conventional roasting time for beans is around 30 min, for nibs about 12 min, and for liquid cacao mass only 2 min. Too long time or too high temperature will result in a bitter and burnt taste. [Beckett, 2009]. The bitter and burnt taste comes from the degradation of polyphenols [Di Mattia et al., 2017] into the formation of 2,5-dimethylprazine, which increases strongly with strong roasting degree, and trimethylpyrazine which increases steadily [Beckett, 2009].

By selecting a genetic variety of the cocoa bean, and not a cultivar, it is ensured that the cocoa bean used in the method of the present invention always has the same unique characteristics, and thus always will respond and react to the optimum roasting profile in the same way. If a cultivar was used it cannot be ensured that one cocoa bean batch has the same characteristics as another batch received e.g. a year later, even if it comes from the same farm.

So by selecting a specific cocoa bean antioxidant-preserving and/or antioxidant-producing roasting profile according to the selected genetic variety, as in the method of the present invention, a chocolate product having a high antioxidant content without need can consistently be manufactured the of establishing the antioxidant-preserving and/or antioxidant-producing roasting profile for each and every batch of cocoa beans, as if cultivar cocoa beans were used, thereby saving considerable manufacturing costs and manpower, and at the same time ensuring the reproduceablity of the high antioxidant content.

It has been realized by the present inventors that the antioxidant content of different genetic cocoa bean varieties differ substantially. Also the storage conditions and the processing conditions influences on the antioxidant content of the raw fermented cocoa bean, thus the roasting profiles of different genetic cocoa bean varieties are mapped.

So it is not a straight forward task to manufacture a palatable chocolate or cocoa mass having a high antioxidant content, such as a specified content of polyphenolic compounds.

Natural antioxidant compounds are lost during heating using conventional roasting profiles, but by selecting cocoa beans according to genetic variety the overall antioxidant properties of the roasted cocoa beans can be maintained and enhanced by the production of new antioxidants, such as Maillard reaction products in the form of the melanoidins [Oracz, Nebesny, 2016], [Oliviero et al., 2009].

In step a) a genetic variety of raw fermented cocoa bean having a natural high content of antioxidants is selected as the raw fermented cocoa bean material for the chocolate to be produced. Next, in step b) the most antioxidant-preserving and/or antioxidant-producing roasting profile is selected and a gentle roasting of said selected genetic variety of raw fermented cocoa bean is performed accordingly. The selected specific antioxidant-preserving and/or antioxidant-producing roasting profile for the chosen cocoa bean will be the roasting profile used for step c) that can be verified as the roasting profile that has the minimum loss of natural antioxidant content after the roasting and preferably the roasting profile that produces the most antioxidants in response to roasting. Thus each of the above processing steps are conducted in view of preserving the naturally occurring antioxidants of the raw fermented cocoa bean and produce antioxidant to compensate for antioxidant content lost during fermentation and drying of the cocoa bean, optionally lost during roasting, to produce roasted cocoa beans having the highest possible content of antioxidants, preferably the highest possible content of polyphenolic compounds.

Pre-step a0) may be performed prior to step a) to easily determine which roasting profile for the available genetic variety of raw fermented cocoa beans is the optimum antioxidant-preserving and/or antioxidant-producing roasting profile.

Pre-step a0) may comprise the initial steps of
determining the initial antioxidant content of at least one selected genetic variety of raw fermented cocoa bean,
subjecting the at least one selected genetic variety of the raw fermented cocoa bean to a plurality of different roasting profiles,
determining the post-roasting antioxidant content of the at least one selected genetic variety of roasted raw fermented cocoa bean after it has been subjected to the plurality of different roasting profiles, and
selecting amongst said plurality of different roasting profiles the roasting profile that provides the highest post-roasting antioxidant content of the at least one genetic variety of raw fermented cocoa bean.

Optionally for each genetic variety of cocoa bean, the initial antioxidant content, the roasting profiles, the roasting profile that has the highest post-roasting antioxidant content, and the corresponding resulting post-roasting antioxidant content of the roasted raw fermented cocoa beans for each roasting profile can be mapped, to make these data a reference and/or standard for facilitating future production of chocolate high in antioxidant content. Preferably the antioxidants are polyphenolic compounds.

In this way the chocolate producing method can be targeted to any genetic variety of raw fermented cocoa bean to optimize antioxidant content of the final chocolate or cocoa mass product. So in step b) the selected specific cocoa bean antioxidant-preserving and/or antioxidant-producing roasting profile is the roasting profile that results in the highest possible content of antioxidants of the cocoa bean after roasting, which content of antioxidants may be a combination of preserved antioxidants naturally occurring in the cocoa bean and antioxidants produced during roasting.

The antioxidants which are given priority to be preserved according to the specific cocoa bean antioxidant-preserving and/or antioxidant-producing roasting profile may preferably comprise polyphenols selected from the group comprising flavanols, proanthocyanidins, and anthocyanidins.

Phenolic compounds diffuse with cell liquids from their storage cells while oxidising into primarily insoluble tannins. The reactions both occur as a catalyzed reaction, by the polyphenol oxidase enzyme and through a non-enzymatic reaction. The polyphenol content are reduced to approximate 10-20% during the fermentation, [Wollgast, Anklam, 2000]. The polyphenols are not only oxidizing but are also diffusing with the sweating during fermentation, so some polyphenolic content are lost during the initial processing of the cocoa bean after harvesting. However due to having chosen a specific cocoa bean antioxidant-preserving and/or antioxidant-producing roasting profile a high content of polyphenols in a subsequently produced chocolate or cocoa mass product can be preserved.

The cocoa bean has the highest content of flavanols of all foods per weight basis [Flores, 2019]. Preferred flavanols to be preserved after roasting may comprises flavanols selected from the group comprising catechin, epicatechin, epigallocatechin, epigallocatechingallate, and epicatechingallate.

Secondary polyphenolic compounds can be produced during enzymatic or non-enzymatic oxidation of flavanols and the antioxidants produced and preserved after roasting according to the specific cocoa bean antioxidant-preserving and/or antioxidant-producing roasting profile may comprise secondary phenolic and non-phenolic compounds.

Preferably the secondary phenolic and non-phenolic compounds comprises compounds selected from the group comprising phenolic acids and methylxanthines. Preferred phenolic acids may comprise acids selected from the group comprising gallic acid, caffeic acid and combinations thereof. Preferred methylxanthines may comprise caffeine, theobromine and combinations thereof.

Important polyphenols that may be aimed for being in the roasted cocoa bean after having been subjected to the method according to the present invention are flavanols selected from the group comprising (+)-catechin, (−)-epicatechin, including epicatechin-(2β→5,4 β→6)-epicatechin, 3T-O-βD-galactopyranosyl-ent-epicatechin-(2α→7,4α→8)-epicatechin, and 3T-O-L-arabinopyranosyl-ent-epicatechin (2α→7, 4α→8)-epicatechin, (−)-epigallocatechin, (−)-epigallocatechingallate and (−)-epicatechingallate.

Further secondary phenolic and non-phenolic compounds aimed for may include quercetin and quercetin glucoside, clovamide, deoxyclovamide, trans-resveratrol and its glucoside (trans-piceid) and procyanidin.

Due to the specific antioxidant-preserving and/or antioxidant-producing roasting profile the antioxidant content of the roasted cocoa beans may be higher than the natural content of antioxidants in the raw fermented cocoa beans, even higher than the natural content of antioxidants in the raw cocoa beans prior to the fermentation, thus any loss of natural antioxidants lost during fermentation and roasting can be compensated and balanced by antioxidants produced when using an antioxidant-preserving and/or antioxidant-producing roasting profile specific to the genetic cocoa bean variety as in the method of the present invention. So the total content of antioxidants after performing the specific antioxidant-preserving and/or antioxidant-producing roasting profile according to the present invention may even be higher than the naturally occurring content of antioxidants of the fresh cocoa bean, so by using the method of the present invention even some genetic varieties that are not especially high in natural antioxidant content may be used to produces roasted cocoa beans having an antioxidant content that is substantially higher than the natural antioxidant content.

There are four main varieties of the cacao plant: Forastero, Criollo, Trinitario, and Nacional, however genetic varieties of cocoa bean selected from the group comprising Forastero, Criollo, or Trinitario are currently expected to be the most promising varieties, partly due to costs, but also in view of roasting the genetic cocoa beans variety to produce a chocolate or cocoa mass having the desired designed target optimum high content of antioxidants.

Bulk cocoa is often Forastero. Forastero beans have strong flavor and are dark purple. The pod is bulbous, woody, and smooth.

Crillo bean pods have knobby, warty skin and pointed pods. Chocolate produced from the expensive Crillo, but robust, Crillo bean has a distinctly white color and an equally distinctive complex taste, which can include flavors of caramel, nuts, vanilla, and tobacco.

Trinitario is a cultivated hybrid between the Criollo and Forastero. Trinitario is the predominant cocoa plant, and is the most frequent used cocoa bean found in high-quality dark chocolate today.

The roasting of step c) may comprise
adding a selected amount of the selected genetic variety of cocoa bean to a roasting chamber,
raising the temperature of said cocoa beans to the selected specific predetermined cocoa bean end temperature of the specific cocoa bean antioxidant-preserving and/or antioxidant-producing roasting profile during the specific predetermined cocoa bean roasting period, and
terminating the roasting at the end of the selected specific predetermined cocoa bean roasting period.

Optionally said selected specific predetermined cocoa bean end temperature is maintained if it is reached prior to the end of the specific predetermined cocoa bean roasting period.

The selected specific predetermined cocoa bean end temperature and the selected specific predetermined cocoa bean roasting period varies depending on the genetic variety of the selected cocoa bean. The selected specific predetermined cocoa bean end temperature and the selected specific predetermined cocoa bean roasting period may already be know in advance, e.g. if these process parameters already have been established and mapped as mentioned in pre-step a0). But for a new genetic variety, optionally for a new batch of a known genetic variety of cocoa beans, pre-step a0) may need to be conducted to establish the optimum specific cocoa bean antioxidant-preserving and/or antioxidant-producing roasting profile.

It is preferred that the roasting chamber is a rotating roasting chamber, such as a rotating drum. More preferred the rotational speed of said rotating roasting chamber may be alternatingly increased and decreased the during selected specific predetermined cocoa bean roasting period to ensure a homogenous gentle roasting process of all cocoa beans.

As the genetic varieties of cocoa beans differ substantially as to antioxidant content, antioxidant composition, it is important that the antioxidant-preserving and/or antioxidant-producing roasting profile match the genetic cocoa bean. Preferred cocoa beans having a high natural content of polyphenols may be Chuno Classico and/or Medalla. Chuno Classico and Medalla are the respective unique tradenames of two cocoa beans of the variety Trinitario from Nicaragua.

The conventional basic roasting technique subjects the cocoa beans to a high temperature initially, and then slowly reduces the temperature, and stops the roasting when the beans are “popping”, but well before they start to burn. This takes between 5-120 minutes at temperature between 100° C. and 160° C. but without taking account of the specific cocoa bean varieties ability to tolerate the selected temperature level and roasting time in view of also preserving antioxidant content, and more important producing antioxidants to increase antioxidant content beyond the natural antioxidant content of the raw fermented cocoa bean during the roasting, to later be able to produce a chocolate or cocoa mass having a very high antioxidant content, even if the fermentation and roasting has destroyed some natural antioxidant content of the cocoa bean.

A selected specific predetermined cocoa bean roasting period to preserve a high antioxidant content of most varieties of raw fermented cocoa beans may be between 18-24 minutes, or more preferred between 19-23 minutes, or more preferred between 20-22 minutes.

When the genetic variety of raw fermented cocoa bean is selected to be a Chuno Classico cocoa bean a high antioxidant content can be obtained by selecting a specific predetermined cocoa bean end temperature of 150° C.±5° C., more preferred 150° C. ±3° C., even more preferred 150° C.±1° C., and most preferred 150° C.

When the genetic variety of raw fermented cocoa bean is selected to be Medalla cocoa bean a high antioxidant content can be obtained by selecting a specific predetermined cocoa bean end temperature of 100° C.±5° C., more preferred 100° C.±3° C., even more preferred 100° C.±1° C., and most preferred 100° C.

Thus the specific predetermined cocoa bean end temperature for Chuno and Medalla are highly different in view of optimizing the antioxidant content of the roasted cocoa bean.

A palatable chocolate having a high cocoa content of at least 70 wt % and a high antioxidant content can be produced of cocoa beans subjected to the method described above.

There are some very important differences in using whole raw beans as the starting material, as in the Russian patent application SU65817 A1, versus using cocoa mass as the starting material as in the present invention, including but not limited to the differences listed below:
cocoa mass has gone through many more production steps such as refining/reducing the particle size (in e.g. a ballmill), conchering (in an industrial conche), alkalizing cocoa powder, deodorizing cocoa butter. It is supposed that these steps reduce the content of antioxidants due to their exposure to mechanical stress, oxygen, hot temperatures, chemicals and other parameters,
cocoa mass is usually diluted with alkalized cocoa powder and cocoa butter. It is supposed that this dilutes the content of antioxidants,
the cocoa butter is the fat in chocolate, and it can crystallize in any one of 6 different forms,-polymorphs, however only one of these, the beta crystal (or Form V), hardens into firm, shiny chocolate. Form VI is also a stable hard crystal, but only small amounts of it form from the good beta (Form V) crystals upon lengthy standing. The process of melting and then cooling melted chocolate so that it will form beta crystals is called tempering. Tempering is necessary only for real chocolate which contains cocoa butter, not for compound chocolate which fats other contains than cocoa butter. Accordingly it is possible to make a 2-ingredient chocolate recipe of 40% cocoa mass and 60% sugar, but it is impossible to make a 2-ingredient chocolate of 40% cocoa beans and 60% sugar, because chocolate must contain minimum 33% cocoa butter to be able to crystallize correctly to Form V during a tempering. In SU65817 A1 the recipe with 40% cocoa mass could consist of 33% cocoa butter and 7% cocoa powder and thus could be done. However a recipe with 40% cocoa beans would only contain approx. 20% cocoa butter (approx. 50% of cocoa beans are in the form of cocoa butter, the rest is considered cocoa solids i.e. cocoa powder).

The chocolate obtained by the method according to the present invention may comprise sugar, preferably unrefined sugar, optionally as the sole additional ingredient in addition to cocoa mass obtained from the cocoa beans subjected to the method described herein.

The chocolate according to the present invention preferably has a content of sugar that is equal to or less than 30% sugar based on the total weight of the chocolate.

Optionally the chocolate produced according to the method according to the present invention may have less than 5 wt % of additional cocoa butter and less than 5 wt % of additional lechitin based on the total weight of the chocolate, less than 4 wt % of additional cocoa butter and less than 4 wt % of additional lechitin based on the total weight of the chocolate, more preferred less than 3 wt % of additional cocoa butter and less than 3 wt % of additional lechitin based on the total weight of the chocolate, even more preferred less than 2 wt % of additional cocoa butter and less than 2 wt % of additional lechitin based on the total weight of the chocolate, more preferred less than 1 wt % of additional cocoa butter and less than 1 wt % of additional lechitin based on the total weight of the chocolate, preferably less than 0.5 wt % of additional cocoa butter and less than 0.5 wt % of additional lechitin based on the total weight of the chocolate, and most preferred the content of additional cocoa butter and additional lechitin based on the total weight of chocolate is 0 wt %, optionally the chocolate has no content of emulgator and/or milk mass.

Most preferred the chocolate produced according to the method of the present invention consists of cocoa beans selected and processed as described above and sugar as the sole additional ingredient, preferably unrefined sugar. Chocolate only comprising cocoa and sugar are extremely difficult to produce, however the method of the present invention facilitates such production, with the additional advantage of the chocolate having extremely high polyphenolic content.

According to the present invention a method of producing a chocolate using the cocoa beans processed using the method according to any of the preceding claim 1-9, may comprise the steps of:
a) roasting said cocoa beans,
b) cracking and winnowing the cocoa beans roasted in step a), and colleting cocoa nibs,
c) refining and conching the cocoa nibs to obtain a chocholate mass, and
e) tempering and molding the chocolate mass into chocholate products of various shapes and sizes.

In step c) during cracking and winnowing the content of cocoa husk (shell) may be reduced to a maximum content of 1% shell among the collected cocoa nibs.

In some embodiments sugar may be added in step c) in an amount that is equal to or less than 30% sugar based on the total weight of the chocolate obtained, whereby both sugar and cocoa nibs will be refined.

In a preferred embodiment step c) can be performed in a melanger.

The cocoa nibs and sugar are preferably refined to a particle size less than or equal to 50 μm.

One step e) has been completed the final chocholate products are packed, and the packages can be labelled for storage and sale.

### EXPERIMENTS

The raw fermented dried cocoa bean of three genetic cocoa bean varieties of the Trinitario variety of Table 1 below was imported by the applicant from Nicaragua and tested for natural antioxidant content before and after roasting, each at three different roasting profiles.

TABLE 1
Tested raw fermented dried cocoa
bean genetic cocoa bean varieties

| Sample code | Name | Country of origin |
|---|---|---|
| NB | Barba | Nicaragua |
| NM | Medalla | Nicaragua |
| NCC | Chuno Classico | Nicaragua |

[symbol]

| Name | Roasting profile | Temperature (° C.) | Time (min.) |
|---|---|---|---|
| Chuno Classico | Light | 100 | 22 |
| | Medium | 125 | 25 |
| | Dark | 150 | 28 |
| Medalla | Light | 100 | 22 |
| | Medium | 125 | 25 |
| | Dark | 150 | 28 |
| Barba | Light | 100 | 22 |
| | Medium | 125 | 25 |
| | Dark | 150 | 28 |

[symbol]

indicates data missing or illegible when filed

Extraction of phenolic compounds from raw fermented cocoa beans was made following the method suggested by Hernández-Hernández et al. by conducting the following steps:
i) Decreasing particle size by grinding after immersing in liquid nitrogen.
ii) Defatting with heptane: 10 mL heptane was added to approximately 1.5 g sample and vortexed for 30 seconds in test tubes. The tubes were transferred to an ultrasonic bath for 10 minutes at 25° C. The tubes were then centrifuged for 10 minutes at 5000 rpm at 20° C. Supernatant was removed from the pellet. This wash with heptane was repeated 3 times before the pellet, which contains the defatted sample, was left to dry with gaseous nitrogen to total dryness.
iii) Extracting phenolic compounds with methanol, water and acetic acid: The defatted samples were split into two new 15 mL test tubes, approximately 0.6 g in each. They were extracted, at 25 mg/mL methanol, water and acetic acid (80:19.5:0.5). After adding the methanol mixture, the samples were vortexed for 30 seconds and placed in an ultrasonic bath in beakers at approximately 25° C. for 10 minutes. After sonication, the samples were transferred to a centrifuge for 10 minutes at 5000 rpm and 5° C. The supernatant was collected in weighted tubes. To increase the extraction of the polyphenols, the extraction was repeated 2 times and the supernatant was pooled. The pooled supernatants were left to dry with gaseous nitrogen in 50 mL test tubes and were completely dry after approximately 24 hours. The extracts were afterwards weighed and stored in a freezer at −18° C. before further analyzes.

For measurement of the total phenolic content (TPC) for the raw and roasted beans the method from [Sabeena Farvin, Jacobsen, with modification, was used. The modification was related to the sodium carbonate. In [Sabeena Farvin, Jacobsen, 2013] they used sodium bicarbonate (6%). In the current experiments sodium carbonate (7.5%) was used. Dilutions of the polyphenol extracts of cocoa and chocolate samples were made with methanol and water. 100 μL of the extracts were transferred to 2 mL cuvettes and then 0.75 mL of Folin-Ciocalteu reagent was added. After 5 minutes 0.75 mL of Sodium Carbonate was added to all the cuvettes and mixed. The reaction was incubated for 90 minutes at room temperature and darkness. After the incubation, the absorbance was measured at 725 nm (SHIMADZU UV-1280, Holm & Halby). For the calibration curve the standard for phenolic compounds was Gallic acid.

For identification of phenolic compounds in the roasting profiles Ultra-high performance liquid chromatography mass spectrometry was used. The extracts were diluted, with help from (UHPLC-MS) shaking machine in a 50:50 water: methanol to achieve a concentration of approximately 5 mg/mL. 1 mL of the samples were transferred to vials through a 0.22 μm syringe filter and placed in the instrument (Vanquish Horizon UHPLC System with ISQ EC, thermo scientific) for analysis. The column used for the analysis was a Zorbax SB-C18 Rapid Resoltion HT (2.1×50 mm, 1.8 Micron, 600 bar, Agilent). The analytes were eluted gradually in two mobile phases; A which contained water with 0.1% formic acid and phase B which contained methanol with 0.1% formic acid. The running time was 17 minutes. The injected volume of analytes was 1.00 μL. The phenolic compound was detected at 235 nm, 255 nm, 280 nm and 325 nm by the photo diode array (PDA) with a DAD and identified by MS with data in total ion chromatogram (TIC). After the quantification was done with MS-quantification using retention time and known standards.

TABLE 3
Total phenolic content (TPC) for raw fermented dried cocoa beans
and for roasted coca beans. (GAE: Gallic Acid Equivalents).

| | | TPC ± SD | | Optimum specific |
|---|---|---|---|---|
| | | (mg GAE/g dry | | cocoa bean |
| | | weight) | | antioxidant-preserving |
| | | Raw fermented | TPC ± SD | and/or antioxidant- |
| Sample | | dried Cocoa | (mg GAE/g dry weight) | producing roasting |
| code | Name | beans | Roasted | profile |
| NB | Barba | 115.5 ± 3.9 | 100° C.; 22 min: 139.8 ± 8.0 | |
| | | | 125° C.; 22 min: 129.8 ± 1.0 | |
| | | | 150° C.; 28 min: 141.1 ± 6.0 | X |
| NM | Medalla | 181.8 ± 1.2 | 100° C.; 22 min: 224.7 ± 3.9 | X2 |
| | | | 125° C.; 25 min: 174.4 ± 0.21 | |
| | | | 150° C.; 28 min: 117.0 ± 14.7 | |
| NCC | Chuno | 116.9 ± 0.56 | 100° C.; 22 min: 135.8 ± 4.0 | |
| | Classico | | 125° C.; 25 min: 141.5 ± 10.0 | |
| | | | 150° C.; 28 min: 150.5 ± 12.4 | X1 |

A calibration curve was made for calculations for TPC using gallic acid as standard. GA was made in a stock solution, which was then diluted into eight descending concentrations. These eight GA dilutions were then tested for TPC using a Folin-Ciocalteu assay [Sabeena Farvin, Jacobsen, 2013] modified by using sodium carbonate (7.5%) instead of sodium bicarbonate (6%). From the absorbance measured, linear regression was made. When the calibration curve was made, the linear regression model was used to calculate the concentration of Gallic acid equivalents (GAE) pr mL extract by using the equation

$$Concentration [ \frac{μ g GAE}{mL extract} ] = ( \frac{Abs - b}{a} )$$

Wherein Abs is the absorbance measured in the spectrophotometer, a is the slope of calibration curve, and b is the intersection with the y-axis. The calibration curve was done twice: Once with dilution in 100% methanol and once diluted in 50:50 methanol and water.

The determined optimum specific cocoa bean antioxidant-preserving and/or antioxidant-producing roasting profile for:
Barba is a dark roasting profile which demonstrated an increased TPC of 22.2%,
Medalla is a light roasting profile which demonstrated a an increased TPC by 23.6%,
Chuno Classico is a dark roasting profile which demonstrated an increased TPC of 28.7%.

The content of phenolic compounds of the three genetic varieties of raw fermented dried and roasted cocoa beans of Table 3 was identified as shown in Table 4.1, 4.2. and 4.3 below.

TABLE 4.1
Barba

| | Raw fermented | | | |
|---|---|---|---|---|
| | dried | Light | Medium | Dark |
| (−)-Catechin | 1.79 ± 0.10 | 2.93 ± 0.13 | 6.03 ± 0.17 | 13.5 ± 1.3 |
| (−)-Epicatechin | 77.04 ± 5.2 | 98.56 ± 4.3 | 96.35 ± 7.8 | 104.7 ± 9.8 |
| Procyanidin | 6.89 ± 1.90 | 11.1 ± 0.13 | 13.2 ± 0.97 | 13.7 ± 1.3 |
| Theobromine | 1224.5 ± 11.4 | 1132.2 ± 42.2 | 643.9 ± 29.3 | 143.5 ± 4.58 |
| (−)-Epicatechingallate | 0.018 ± 0.003 | 0.043 ± 0.01 | 0.016 ± 0.008 | 0.052 ± 0.02 |

TABLE 4.2
Medalla

| | Raw fermented | | | |
|---|---|---|---|---|
| | dried | Light | Medium | Dark |
| (−)-Catechin | 3.43 ± 0.10 | 6.68 ± 0.31 | 5.67 ± 0.04 | 6.72 ± 0.50 |
| (−)-Epicatechin | 133.2 ± 3.1 | 257.8 ± 7.5 | 152.5 ± 5.0 | 69.58 ± 9.2 |
| Procyanidin | 23.5 ± 0.11 | 43.9 ± 0.71 | 28.9 ± 1.0 | 11.9 ± 2.6 |
| Theobromine | 1184.3 ± 8.46 | 1049.2 ± 45.4 | 812.4 ± 1.22 | 200.9 ± 18.8 |
| (−)-Epicatechingallate | 0.026 ± 0.01 | 0.029 ± 0.004 | 0.026 ± 0.003 | 0.023 ± 0.004 |

TABLE 4.3
Chuno Classico

| | Raw fermented | | | |
|---|---|---|---|---|
| | dried | Light | Medium | Dark |
| (−)-Catechin | 2.45 ± 0.02 | 4.20 ± 0.26 | 6.02 ± 0.07 | 13.6 ± 0.25 |
| (−)-Epicatechin | 74.34 ± 2.2 | 127.6 ± 7.5 | 102.1 ± 0.7 | 113.3 ± 2.8 |
| Procyanidin | 11.7 ± 0.3 | 20.8 ± 0.93 | 19.6 ± 1.0 | 18.2 ± 1.2 |
| Theobromine | 1386.4 ± 41.2 | 1272.2 ± 45.3 | 783.5 ± 37.7 | 197.0 ± 9.36 |
| (−)-Epicatechingallate | 0.013 ± 0.002 | 0.021 ± 0.005 | 0.025 ± 0.007 | 0.007 ± 0.002 |

Chocolates were produced of 100 wt % Chuno Classico dark roasted (X1 in Table 3) and 100 wt % Medalla light roasted cocoa (X2 in Table 3) and tested using the same methods as for the cocoa beans for TPC and individual phenolic compounds.

Similar tests were made for some commercially obtained chocolates. The results of the commercially obtained chocolates have been compensated by proportional calculation to correspond to a cocoa content of 100 wt %.

TABLE 5
TPC content of different chocolate products

| | TPC ± SD |
|---|---|
| Sample | (mg GAE/g dry weight) |
| Chuno Classico dark roasted according to the | 182.8 ± 2.3 |
| present invention (NCC) | |
| Medalla light roasted according to the present | 202.7 ± 0.39 |
| invention (NM) | |
| Marabou milk chocolate | 3.67 ± 0.14 |
| 70 wt % ØGO Dark Chocolate | 47.1 ± 2.6 |
| Carletti vekao | 3.50 ± 0.04 |
| 70 wt % Lindt Excellence | 32.7 ± 1.5b |

TABLE 6
Content of individual phenolic compounds.

| | NCC | NM | Marabou | ØGO | Charletti | Lindt |
|---|---|---|---|---|---|---|
| (−)-Catechin | 13.9 ± 0.11 | 4.27 ± 0.21 | 1.07 ± 0.09 | 7.01 ± 0.20 | 2.63 ± 0.14 | 3.98 ± 0.33 |
| (−)-Epicatechin | 107.2 ± 0.86 | 190.1 ± 0.96 | 10.17 ± 0.31 | 61.15 ± 0.28 | 7.25 ± 0.46 | 35.44 ± 4.18 |
| Procyanidin | 20.42 ± 0.81 | 37.15 ± 0.09 | 1.73 ± 0.06 | 12.89 ± 0.41 | 0.83 ± 0.01 | 6.81 ± 1.01 |
| Theobromine | 128.7 ± 0.31 | 1297.0 ± 30.7 | 495.2 ± 12.8 | 827.3 ± 2.5 | 143.9 ± 6.8 | 8303.8 ± 7.1 |
| (−)-Epicatechin- | 0.027 ± 0.013 | 0.028 ± 0.012 | 0.010 ± 0.007 | 0.071 ± 0.004 | 0.011 ± 0.003 | 0.012 ± 0.012 |
| gallate | | | | | | |

Before the above analyzes were made, both the raw beans, roasted beans and chocolates were blended with liquid nitrogen in a blender (Commercial blender, Waring® to get the correct particle sizes of approximate 1.00-1.20 mm.

### REFERENCES

Barisic Veronika, Kopjar Mirela, Jozinovic Antun, Flanjak Ivana, Ackar Durdica, Milicevic Borrislav, Subaric Drago, Jokic Stela, Babic Jurislav. The chemistry behind chocolate production. Molecules 2019, 24 (17), 3163; https://doi.org/10.3390/molecules24173163.
Di Mattia Carla D., Sacchetti Giampiero, Mastrocola Dino, Serafini Mauro. From cocoa to chocolate: The impact of processing on in vitro antioxidant activity and the ed ects of chocolate on antioxidant markers in vivo. Frontiers in Immunology. 2017, 8, September 1-7.
Wollgast Jan, Anklam Elke. Review on polyphenols in Theobroma cacao: changes in composition during the manufacture of chocolate and methodology for identification and quantification. July 2000, Food Research International 33 (6): 423-447. DOI: 10.1016/S0963-9969 (00) 00068-5.
Opitz Sebastian E. W., Smrke Samo, Goodman Bernard A., Yeretzian Chahan. Methodology for the Measurement of Antioxidant Capacity of Coffee: A Validated Platform Composed of Three Complementary Antioxidant Assays. June 2014. DOI: 10.1016/B978-O-12-404738-9.00026-X. In book: Processing and Impact on Antioxidants in Beverages (pp. 253-264).
Beckett Stephen T. Industrial Chocolate Manufacture and Use: Fourth Edition. 2009. 1-688. ISBN-13:978-1405139496. ISBN-10:1405139498.
Oracz Joanna, Nebesny Ewa. Antioxidant Properties of Cocoa Beans (Theobroma cacao L.): Influence of Cultivar and Roasting Conditions. International Journal of Food Properties. Volume 19, 2016-Issue 6. Pages 1242-1258.
Richelle, M.; Tavazzi, I.; Offord, E. Comparison of antioxidant activity of commonly consumed polyphenolic beverages (coffee, cocoa, and tea) prepared per cup serving. J. Agric. Food Chem. 2001, 49, 3438-3442.
Oliviero Teresa, Capuano Edoardo, Cammerer Bettina, Fogliano Vincenzo. Influence of roasting on the antioxidant activity and HMF formation of a cocoa bean model systems. Journal of Agricultural and Food Chemistry. 1 2009. 57, 1. 147-152.
Sabeena Farvin K. H., Jacobsen Charlotte. Phenolic compounds and antioxidant activities of selected species of seaweeds from Danish coast. Food Chemistry. 2013. 138, 2-3. 1670-1681.
Flores Maria Eugenia Jaramillo. Cocoa flavanols: Natural agents with attenuating ed ects on metabolic syndrome risk factors. Nutrients. 4 2019. 11, 4.
Hernández-Hernández Carolina, Viera-Alcaide Isabel, Morales-Sillero Ana María, Fernández-Bolanos Juan, Rodríguez-Gutiérrez Guillermo. Bioactive compounds in Mexican genotypes of cocoa cotyledon and husk. Food Chemistry. 2018. 240, August. 831-839.

1. A method of processing cocoa beans for producing a chocolate that is high in antioxidant content, which method comprises the steps of:
a) selecting a genetic variety of raw fermented cocoa bean having a natural high content of antioxidants,
b) selecting a specific cocoa bean antioxidant-preserving and/or antioxidant-producing roasting profile according to said genetic variety of raw fermented cocoa bean, wherein at least a cocoa bean end temperature and a roasting period is established and selected, and wherein the cocoa bean end temperature is the maximum temperature that the genetic variety of raw fermented cocoa beans reach during roasting according to said specific cocoa bean antioxidant-preserving and/or antioxidant-producing roasting profile, and
c) roasting the genetic variety of raw fermented cocoa bean according to the selected specific cocoa bean antioxidant-preserving and/or antioxidant-producing roasting profile.

2. The method according to claim 1 comprising pre-step a0) prior to step a), wherein pre-step a0) comprises:
determining the initial antioxidant content of at least one selected genetic variety of raw fermented cocoa bean,
subjecting the at least one selected genetic variety of the raw fermented cocoa bean to a plurality of different roasting profiles,
determining the post-roasting antioxidant content of the at least one selected genetic variety of roasted raw fermented cocoa bean after it has been subjected to the plurality of different roasting profiles, and electing amongst said plurality of different roasting profiles the roasting profile that has the highest post-roasting antioxidant content for the at least one genetic variety of raw fermented cocoa bean,
optionally mapping for each genetic variety of cocoa bean, the initial antioxidant content, the roasting profiles, the roasting profile that has the highest post-roasting antioxidant content, and the corresponding resulting post-roasting antioxidant content of the roasted raw fermented cocoa beans for each roasting profile.

3. The method according to claim 1,
wherein antioxidants preserved after the antioxidant-preserving and/or antioxidant-producing roasting profile comprises polyphenols selected from the group comprising flavanols, proanthocyanidins, and anthocyanidins; preferred flavanols comprises flavanols selected from the group comprising catechin, epicatechin, epigallocatechin, epigallocatechingallate and epicatechingallate, and
wherein antioxidants produced and preserved after roasting according to the specific cocoa bean antioxidant-preserving and/or antioxidant-producing roasting profile comprises secondary phenolic and non-phenolic compounds; preferably the secondary phenolic and non-phenolic compounds comprises compounds selected from the group comprising phenolic acids and methylxanthines; preferred phenolic acids comprises acids selected from the group comprising gallic acid, caffeic acid and combinations thereof, preferred methylxanthines comprises caffeine, theobromine and combinations thereof.

4. The method according to claim 1, wherein step c) comprises:
adding a selected amount of the selected genetic variety of cocoa bean to a roasting chamber,
raising the temperature of said cocoa beans to the selected specific predetermined cocoa bean end temperature of the specific cocoa bean antioxidant-preserving and/or antioxidant-producing roasting profile during the selected specific predetermined cocoa bean roasting period, and
terminating the roasting at the end of the selected specific predetermined cocoa bean roasting profile.

5. The method according to claim 4, wherein the roasting chamber is a rotating roasting chamber, and the rotational speed is alternatingly increased and decreased during the selected specific predetermined cocoa bean roasting profile.

6. The method according to claim 1, wherein the selected genetic variety of cocoa bean is selected from the group comprising Chuno cocoa bean or Medalla cocoa bean.

7. The method according to claim 1, wherein the selected specific predetermined cocoa bean roasting period is between 18-24 minutes.

8. The method according to claim 6, wherein the selected specific predetermined cocoa bean end temperature of Chuno cocoa bean is 150° C.±5° C.

9. The method according to claim 6, wherein the selected specific predetermined cocoa bean end temperature of Medalla cocoa bean is 100° C.±5° C.

10. A chocolate produced of cocoa beans subjected to the method according to claim 1, wherein the only additional ingredient is sugar.

11. The chocolate according to 10, wherein the sugar is unrefined sugar.

12. The chocolate according to claim 10 wherein the content of sugar is equal to or less than 30% sugar based on the total weight of the chocolate.

13. The chocolate according to claim 10, wherein in addition to sugar additional cocoa butter and/or additional letchitin is/are added so that the chocholate has less than 5 wt % of additional cocoa butter and less than 5 wt % of additional letchitin based on the total weight of the chocolate, less than 4 wt % of additional cocoa butter and less than 4 wt % of additional letchitin based on the total weight of the chocolate, more preferred less than 3 wt % of additional cocoa butter and less than 3 wt % of additional letchitin based on the total weight of the chocolate, even more preferred less than 2 wt % of additional cocoa butter and less than 2 wt % of additional letchitin based on the total weight of the chocolate, more preferred less than 1 wt % of additional cocoa butter and less than 1 wt % of additional letchitin based on the total weight of the chocolate, preferably less than 0.5 wt % of additional cocoa butter and less than 0.5 wt % of additional letchitin based on the total weight of the chocolate, and most preferred the content of additional cocoa butter and additional letchitin based on the total weight of chocolate is 0 wt %, optionally the chocolate has no content of emulgator and/or milk powder.

14. The method of producing a chocolate using the cocoa beans processed using the method according to claim 1 wherein the only additional ingredient is sugar, comprising the steps of:
a) roasting said cocoa beans,
b) cracking and winnowing the cocoa beans roasted in step a) and collecting cocoa nibs,
c) refining and conching the cocoa nibs to obtain a chocholate mass, and
e) tempering and molding the chocolate mass into chocholate products of various shapes and sizes.

15. The method according to claim 14, wherein in step c) during cracking and winnowing the content of cocoa husk (shell) is reduced to a maximum content of 1% shell among the collected cocoa nibs.

16. The method according to claim 14, wherein in step c) sugar is added in an amount that is equal to or less than 30% sugar based on the total weight of the chocolate mass.

17. The method according to claim 14, wherein step c) is performed in a melanger.

18. The method according to claim 14, wherein in step c) cocoa nibs and sugar are refined to a particle size less than or equal to 50 μm.
